(19) United States
(12) Patent Application Publication
(10) Pub. No.: US 2004/0190309 A1
(43) Pub. Date: Sep. 30, 2004

(54) Hanging ornament

(76) Inventors: Kevin Lynn Bixler, Littleton, CO (US); Deanna Gail Bixler, Littleton, CO (US); Keith Robert Bean, Johnstown, CO (US)

Correspondence Address: The Law Office of Craig W. Barber, PO Box 16220, Golden, CO, 80402-6004, US

(21) Appl. No.: 10/403,776

(22) Filed: Mar. 31, 2003

(51) Int. Cl. F21S 4/00

(52) U.S. Cl. 362/565

(57) ABSTRACT

A hanging ornament having a central core and a plurality of radiating spires. Each spire is solid and allows light to pass. Within each spire is wiring and a string of small lights. An electrical cord having a plug suitable for connection to local electrical outlets leads to wiring within the core, which in turn provides electricity to a plurality of sockets. Each socket connects one spire to the core and further connects the core wiring to the spire wiring. Each spire may be removed individually and replaced should the lights within malfunction or the spire become broken. This also aids space saving storage of the invention. In embodiments, the lights of the spire may be mini lights, sub-miniature lights, light emitting diodes, high intensity light emitting diodes or combinations thereof. In other embodiments, the light passing spires may be textured, transparent, translucent, clear or colored, and in yet other embodiments, removable sheaths may be employed on the spires to provide color and/or to the light emitted by the spires. Various other embodiments are detailed in the body of the present document.

### FIELD OF THE INVENTION

This invention relates generally to ornaments and specifically to a lighted hanging ornament such as a star, a cross or having radiating elements, ornaments simulative of a star, seasonal or religious ornaments or ornaments having plural light sources.

### BACKGROUND OF THE INVENTION

The present invention relates to ornaments such as are hung from trees at Christmas, Easter, Halloween, New Years, and numerous other holidays. Such ornaments are also hung year round to convey a spirit of festivity at residences or commercial locations. Large ornaments such as the invention relates to are generally hung out of doors, but it is entirely practical to make such ornaments smaller in dimension and hang them inside, or from very large indoor trees. Ornaments of the type may also be hung from supports other than trees. At least two types of lights may be used: miniature lights such as are commonly sold in the US at Christmas time, and sub-miniature lights, which are normally used for other purposes such as illuminating theater or airliner walkways.

The applicant has carried out a search using the classification system promulgated by the United States Patent and Trademark Office. Relevant prior art patent documents located are listed and discussed below.

Patent Publication No. US 2003/0016544, published Jan. 23, 2003 in the name Huang and entitled STRUCTURE OF FIREWORK LIGHT teaches a base having a single post projecting therefrom and a hollow ball upon the top of the post. Projecting from the hollow ball are numerous tubes which contain wiring leading to a plurality of small lights arranged in a generally spherical pattern at the end of each tube. It does not teach use of any transparent spires.

Patent Publication No. US 2002/0141184 published Oct. 3, 2002 in the name of Shieh and entitled GLOBULAR DECORATIVE LIGHT ASSEMBLY WITH FLEXIBLE SUPPORTING FRAME does not use radiating multiple spires of any type.

Patent Publication No. US 2002/0097577, published for opposition Jul. 25, 2002 in the name Huang and entitled MINI FIRECRACKER LIGHT teaches a single hollow transparent pipe having a plurality of lights within it, and further having a spray of lights projecting from the top of the pipe. It does not teach molding of a jig, use of a solid spire, nor a central point from which a multiplicity of spires might radiate.

U.S. Pat. No. 6,394,624 issued May 28, 2002 to Hsu for DECORATIVE ARTIFICIAL ICICLE teaches a decoration with a transparent shell including a tubular body within having thereon a lampset of mini-lights. The device does not disclose a jig for use in manufacturing, a solid spire, nor a plurality of radiating spires, nor the use of sub-miniature lights. A related patent is U.S. Pat. No. 6,224,239 issued May 1, 2001 to Adler for DECORATIVE LAMP FIXTURE WITH ICICLE SHAPE HAVING INTERIOR WITH PLURALITY OF VERTICALLY-SPACE LIGHTS, in which the lights are retained on the inner wall of the icicle. Yet another icicle patent of dissimilar structure may be seen in U.S. Pat. No. 3,704,365 issued Nov. 28, 1972 to Miller.

U.S. Pat. No. 6,394,623 issued May 28, 2002 to Tsui for TRANSLUCENT FLEXIBLE ROPE LIGHT AND METHOD OF FORMING AND USING SAME teaches a flexible set of sub-miniature lights, and specifically mentions ornamental applications. The device does not teach a radiating set of rigid, molded, spires.

U.S. Pat. No. 6,312,141 issued Nov. 6, 2001 to Liu for SIMULATED FIREWORKS LAMP ASSEMBLY also concerns a light set for simulating a firework, as such firework simulations are popular for business advertisements in some regions of the world. Lights simulating the pattern of a firework explosion, and further simulating flight of sparks out the length of radiating “levers”. It does not teach rigid spires for a hanging ornament, nor the use of sub-miniature lights within solid transparent spires.

U.S. Pat. No. 6,070,991 issued Jun. 6, 2000 to Rumpel for DECORATIVE LIGHT FIXTURE teaches a spherical framework for mounting of lights. It does not use radiating spires of any type.

U.S. Pat. No. 6,036,335 issued Mar. 14, 2000 to Openiano for CUT-TO-LENGTH LINEAR LIGHTING, AND TWO-DIMENSIONAL AND THREE-DIMENSIONAL DECORATIVE LIGHTS, FROM OMNI-DIRECTIONAL LED LAMPS, teaches a type of linear lighting unrelated to ornaments and having no solid molded spires.

U.S. Pat. No. 5,865,533 issued Feb. 2, 1999 to Liu for IMITATED FIREWORKS BULB SET FOR CHRISTMAS TREE DECORATION teaches hollow spheres with sprays of fibre optic cables within.

U.S. Pat. No. 5,772,312 issued Jun. 30, 1998 to Pihl-Niederman et al for LIGHTED HOLIDAY ORNAMENT teaches a hollow spherical shell which houses a string of lights. Translucent members or apertures in the hollow shell allow light to escape the ornament. There are no transparent solid spires.

U.S. Pat. No. 5,645,343 issued Jul. 8, 1997 to Rinehimer for LIGHT-STRING HOLDER teaches a light string holder in a generally spherical shape comprising a plurality of translucent lamp-cluster holders. There are no spires. U.S. Pat. No. 5,876,111 issued Mar. 2, 1999 to Wu for DECORATIVE LIGHTING STRING WITH EXPANDABLE, SHRINKABLE AND THREE-DIMENSIONAL UNIT is generally similar.

Two patents relating to retention of lights on a structural member are U.S. Pat. No. 5,526,246 issued Jun. 11, 1996 to Liou for POSITIONING STRUCTURE FOR A PATTERN OF A DECORATIVE LAMP STRING, and U.S. Pat. No. 5,664,877 issued Sep. 9, 1997 to Wu for DECORATIVE LAMP STRING ASSEMBLY teach multi-piece retainers using clips to retain a string of minilights (not sub-miniature lights) on a strip of material. The retainer does not appear to function as a jig in making a larger SOLID structure.

U.S. Pat. No. 4,665,470 issued May 12, 1987 to George, Jr, for DECORATIVE LIGHT TUBING AND METHOD OF MANUFACTURE THEREOF teaches that a hollow tube may enclose a string of lights and a protective dielectric material for cushioning against moisture, shock and vibration. It does not teach a hanging ornament having multiple rigid and solid spires.

U.S. Pat. No. 4,179,832 issued Dec. 25, 1979 to Lemelson for INFLATABLE DISPLAYS teaches an inflatable (non-solid) display having lights within a flexible transparent structure possibly simulating a Christmas tree shape.

U.S. Pat. No. 3,755,663 issued Aug. 28, 1973 to George, Jr. for ELECTRICAL DISPLAY DEVICE AND METHOD OF MAKING THE SAME teaches a string of miniature (sub-miniature?) lights in a flexible housing. It discloses that such devices may be bent into decorative shapes, unlike most patents in the unrelated “lighting” technology. However, it does not disclose use of solid molded radiating spires.

U.S. Pat. No. 3,272,976 issued Sep. 13, 1966 to Charchan et al for STAR SHAPED ORNAMENT teaches a star shaped ornament supporting mini-lights rather than sub-miniature lights. It further lacks transparent spires. U.S. Pat. No. 6,179,442 issued Jan. 30, 2001 to Schurle for CHRISTMAS STAR LIGHT DEVICE teaches a modular lighted light construction set which does not appear to use solid molded spires, while U.S. Pat. No. 5,430,626 issued Jul. 4, 1995 to Leffel for ILLUMINATED DISPLAY CONSTRUCTION also teaches light up stars, as does U.S. Pat. No. 6,478,455 issued Nov. 12, 2002 to Ahroni for DECORATIVE LIGHTING APPARATUS.

### SUMMARY OF THE INVENTION

### General Summary

The present invention teaches a hanging ornament having a central core and a plurality of radiating spires. Each spire is solid and allows light to pass. Within each spire is wiring and a string of small lights. An electrical cord having a plug suitable for connection to local electrical outlets leads to wiring within the core, which in turn provides electricity to a plurality of sockets. Each socket connects one spire to the core and further connects the core wiring to the spire wiring. Each spire may be removed individually and replaced should the lights within malfunction or the spire become broken. This also aids space saving storage of the invention. In embodiments, the lights of the spire may be mini lights, sub-miniature lights, light emitting diodes, high intensity light emitting diodes or combinations thereof. In other embodiments, the light passing spires may be textured, transparent, translucent, clear or colored, and in yet other embodiments, removable sheaths may be employed on the spires to provide color and/or texture to the spires and to the light emitted by the spires. Various other embodiments are detailed in the body of the present document.

### Summary in Reference to Claims

It is therefore one aspect, advantage, objective, and embodiment of the invention to provide a hanging ornament comprising: an electrical cord having a plug; a core having a plurality of sockets and having core wiring extending to each socket; a plurality of light passing spires extending radially from the core; each spire physically connected to one of the sockets; each spire having spire wiring therein in operative connection to the core wiring at the socket to which the spire is physically connected; whereby an operative electrical connection is established to the spire wiring of each spire; each set of spire wiring having a plurality of small lights within the light passing spire.

It is therefore one more aspect, advantage, objective, and embodiment of the invention to provide an ornament wherein each of the plurality of light passing spires is furthermore solid.

It is therefore one more aspect, advantage, objective, and embodiment of the invention to provide an ornament wherein the core further comprises a cavity within the core, and wherein each of the plurality of sockets further comprises an aperture extending from the cavity to the exterior of the core.

It is therefore one more aspect, advantage, objective, and embodiment of the invention to provide an ornament wherein the core wiring is disposed within the cavity.

It is therefore one more aspect, advantage, objective, and embodiment of the invention to provide an ornament wherein the plurality of small lights within the light passing spire are in serial electrical relationship to one another.

It is therefore one more aspect, advantage, objective, and embodiment of the invention to provide an ornament wherein the plurality of small lights within the light passing spire further comprise miniature light bulbs.

It is therefore one more aspect, advantage, objective, and embodiment of the invention to provide an ornament wherein the plurality of small lights within the light passing spire further comprise sub-miniature light bulbs.

It is therefore one more aspect, advantage, objective, and embodiment of the invention to provide an ornament wherein the plurality of small lights within the light passing spire further comprise light emitting diodes.

It is therefore one more aspect, advantage, objective, and embodiment of the invention to provide an ornament wherein the plurality of light emitting diodes within the light passing spire further comprise high intensity light emitting diodes.

It is therefore one more aspect, advantage, objective, and embodiment of the invention to provide an ornament wherein each light passing spire further comprises: a plurality of wiring voids; a plurality of light bulb voids; at least first and second individual spire components, each spire component being dimensioned and configured to physically connect to the other spire component in a physical relationship which leaves only the wiring voids and the light bulb voids; each light bulb void being substantially occupied by one light bulb; and each wiring void being substantially occupied by one section of spire wiring.

It is therefore one more aspect, advantage, objective, and embodiment of the invention to provide an ornament wherein the first and second spire components are identical.

It is therefore one more aspect, advantage, objective, and embodiment of the invention to provide an ornament wherein the first spire component further comprises a jig holding the spire wiring and small light bulbs.

It is therefore one more aspect, advantage, objective, and embodiment of the invention to provide an ornament wherein the spires are rigid.

It is therefore one more aspect, advantage, objective, and embodiment of the invention to provide an ornament wherein the spires are flexible.

It is therefore one more aspect, advantage, objective, and embodiment of the invention to provide an ornament wherein each spire may be individually removed from the socket to which it is physically connected.

It is therefore one more aspect, advantage, objective, and embodiment of the invention to provide an ornament wherein the operative connection between the core wiring and the spire wiring at each socket permits removal of the spire in the socket without physical disassembly of the wiring.

It is therefore one more aspect, advantage, objective, and embodiment of the invention to provide an ornament wherein the exterior of the spires comprises a texture selected from the group consisting of: smooth texture, faceted texture, knurled texture, straight grooved texture, spiraled grooved texture, and combinations thereof.

It is therefore one more aspect, advantage, objective, and embodiment of the invention to provide an ornament wherein the spires further comprise a material selected from the group consisting of: clear polymer, transparent colored polymer, translucent polymer, clear glass, transparent colored glass, translucent glass, and combinations thereof.

It is therefore one more aspect, advantage, objective, and embodiment of the invention to provide an ornament wherein the polymer is selected from the group consisting of clear hard PVC, acrylic, polycarbonate, PETG and combinations thereof.

It is therefore one more aspect, advantage, objective, and embodiment of the invention to provide an ornament wherein each spire further comprises: at least one removable light passing sheath covering the exterior surface of the spire, wherein the light passing sheath is selected from the group consisting of: clear polymer, transparent colored polymer, translucent polymer, clear glass, transparent colored glass, translucent glass, and combinations thereof. This may provide color and/or texture.

It is therefore one more aspect, advantage, objective, and embodiment of the invention to provide an ornament further comprising at least one light disposed at the core, the light in operative connection with the core wiring.

It is therefore one more aspect, advantage, objective, and embodiment of the invention to provide an ornament wherein each spire further comprises: a second spire wiring therein in operative connection to the core wiring at the socket to which the spire is physically connected; whereby an operative electrical connection is established to the second spire wiring of each spire; each second set of spire wiring having a plurality of small lights within the light passing spire.

It is therefore one more aspect, advantage, objective, and embodiment of the invention to provide an ornament wherein the small lights are colored.

It is therefore one more aspect, advantage, objective, and embodiment of the invention to provide an ornament further comprising means for timed control of the electrical supply of the small lights.

It is therefore one more aspect, advantage, objective, and embodiment of the invention to provide an ornament wherein the plurality of small lights within the light passing spire are in serial electrical relationship to one another.

It is therefore one more aspect, advantage, objective, and embodiment of the invention to provide an ornament further comprising: at least one electrically actuated sound device in operative connection to the electrical cord, whereby the device may make sound when in operation.

It is therefore a first aspect, advantage, objective, and embodiment of the invention to provide a hanging ornament comprising: an electrical cord having a plug; a core having a plurality of sockets and having core wiring extending to each socket, the core wiring being operatively electrically connected to the electrical cord; a plurality of light passing spires extending radially from the core; each spire physically connected to one of the sockets; each spire having spire wiring therein in operative connection to the core wiring at the socket to which the spire is physically connected; whereby an operative electrical connection is established to the spire wiring of each spire; each set of spire wiring having a plurality of small lights within the light passing spire.

It is therefore one more aspect, advantage, objective, and embodiment of the invention to provide an ornament wherein each of the plurality of light passing spires is furthermore solid.

It is therefore one more aspect, advantage, objective, and embodiment of the invention to provide an ornament wherein the core further comprises a cavity within the core, and wherein each of the plurality of sockets further comprises an aperture extending from the cavity to the exterior of the core.

It is therefore one more aspect, advantage, objective, and embodiment of the invention to provide an ornament wherein the core wiring is disposed within the cavity.

It is therefore one more aspect, advantage, objective, and embodiment of the invention to provide an ornament wherein the plurality of small lights within the light passing spire are in serial electrical relationship to one another.

It is therefore one more aspect, advantage, objective, and embodiment of the invention to provide an ornament wherein the plurality of small lights within the light passing spire further comprise miniature light bulbs.

It is therefore one more aspect, advantage, objective, and embodiment of the invention to provide an ornament wherein the plurality of small lights within the light passing spire further comprise sub-miniature light bulbs.

It is therefore one more aspect, advantage, objective, and embodiment of the invention to provide an ornament wherein the plurality of small lights within the light passing spire further comprise light emitting diodes.

It is therefore one more aspect, advantage, objective, and embodiment of the invention to provide an ornament wherein the plurality of light emitting diodes within the light passing spire further comprise high intensity light emitting diodes.

It is therefore one more aspect, advantage, objective, and embodiment of the invention to provide an ornament wherein each light passing spire further comprises: a plurality of wiring voids; a plurality of light bulb voids; at least first and second individual spire components, each spire component being dimensioned and configured to physically connect to the other spire component in a physical relationship which leaves only the wiring voids and the light bulb voids; each light bulb void being substantially occupied by one light bulb; and each wiring void being substantially occupied by one section of spire wiring.

It is therefore one more aspect, advantage, objective, and embodiment of the invention to provide an ornament wherein the first and second spire components are identical.

It is therefore one more aspect, advantage, objective, and embodiment of the invention to provide an ornament wherein the first spire component further comprises a jig holding the spire wiring and small light bulbs.

It is therefore one more aspect, advantage, objective, and embodiment of the invention to provide an ornament wherein the spires are rigid.

It is therefore one more aspect, advantage, objective, and embodiment of the invention to provide an ornament wherein the spires are flexible.

It is therefore one more aspect, advantage, objective, and embodiment of the invention to provide an ornament wherein each spire may be individually removed from the socket to which it is physically connected.

It is therefore one more aspect, advantage, objective, and embodiment of the invention to provide an ornament wherein the operative connection between the core wiring and the spire wiring at each socket permits removal of the spire in the socket without physical disassembly of the wiring.

It is therefore one more aspect, advantage, objective, and embodiment of the invention to provide an ornament wherein the exterior of the spires comprises a texture selected from the group consisting of: smooth texture, faceted texture, knurled texture, straight grooved texture, spiraled grooved texture, and combinations thereof.

It is therefore one more aspect, advantage, objective, and embodiment of the invention to provide an ornament wherein the spires further comprise a material selected from the group consisting of: clear polymer, transparent colored polymer, translucent polymer, clear glass, transparent colored glass, translucent glass, and combinations thereof.

It is therefore one more aspect, advantage, objective, and embodiment of the invention to provide an ornament wherein the polymer is selected from the group consisting of clear hard PVC, acrylic, polycarbonate, PETG and combinations thereof.

It is therefore one more aspect, advantage, objective, and embodiment of the invention to provide an ornament wherein each spire further comprises: at least one removable light passing sheath covering the exterior surface of the spire, wherein the light passing sheath is selected from the group consisting of: clear polymer, transparent colored polymer, translucent polymer, clear glass, transparent colored glass, translucent glass, and combinations thereof.

It is therefore one more aspect, advantage, objective, and embodiment of the invention to provide an ornament further comprising at least one light disposed at the core, the light in operative connection with the core wiring.

It is therefore one more aspect, advantage, objective, and embodiment of the invention to provide an ornament wherein the core further possesses at least one limitation selected from the list comprising: decorative surface texture, decorative shape, decorative color.

It is therefore one more aspect, advantage, objective, and embodiment of the invention to provide an ornament wherein each spire further comprises: a second spire wiring therein in operative connection to the core wiring at the socket to which the spire is physically connected; whereby an operative electrical connection is established to the second spire wiring of each spire; each second set of spire wiring having a plurality of small lights within the light passing spire.

It is therefore one more aspect, advantage, objective, and embodiment of the invention to provide an ornament wherein the small lights are colored.

It is therefore one more aspect, advantage, objective, and embodiment of the invention to provide an ornament further comprising means for timed control of the electrical supply of the small lights.

It is therefore one more aspect, advantage, objective, and embodiment of the invention to provide an ornament wherein the plurality of small lights within the light passing spire are in parallel electrical relationship to one another.

It is therefore one more aspect, advantage, objective, and embodiment of the invention to provide an ornament further comprising: at least one electrically actuated sound device in operative connection to the electrical cord, whereby the device may make sound when in operation.

It is therefore one more aspect, advantage, objective, and embodiment of the invention to provide an ornament wherein a first one of the plurality of spires has a first length, and a second one of the plurality of spires has a second length.

It is therefore one more aspect, advantage, objective, and embodiment of the invention to provide an ornament

### BRIEF DESCRIPTION OF THE DRAWINGS

FIG. 1 is an oblique perspective view of the preferred embodiment of the invention, showing only overall structure.

FIG. 2 is an exploded frontal view of the invention, showing major components of the invention.

FIG. 3 is a partially exploded oblique perspective view of the core and sockets of the invention.

FIG. 4 is an exploded oblique perspective view of the core of the invention without sockets.

FIG. 5 is a oblique elevated view of one spire component with spire wiring and sub-miniature lights ready for insertion therein.

FIG. 6 is an oblique/side exploded view of one spire showing two spire components, spire wiring and sub-miniature lights during assembly of the spire.

FIG. 7 is an oblique/side view of one socket of the invention showing partial core wiring.

FIG. 8 is a bottom view of one socket of the invention showing partial core wiring.

### DETAILED DESCRIPTION

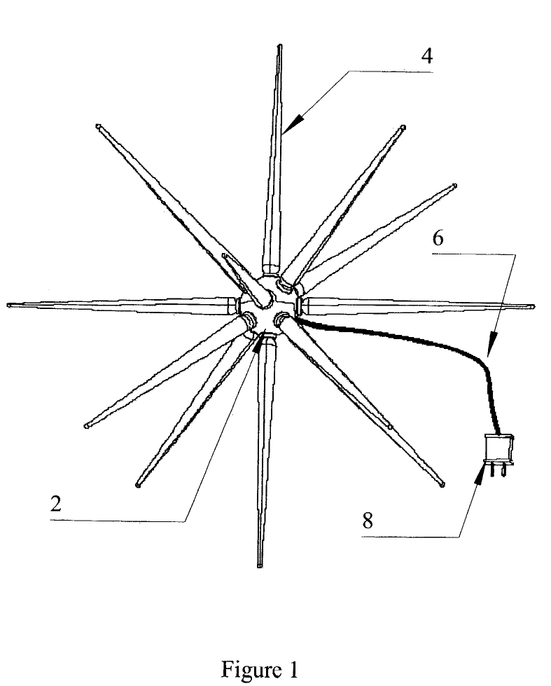

FIG. 1 is an oblique perspective view of the preferred embodiment of the invention, showing only overall structure. The invention is a hanging ornament intended to be suspended from such locations as trees, eaves, balconies or other overhanging structures or flora.

Electrical cord 6 has plug 8. Electrical cord 6 may also serve as the suspension device or a separate suspension device may be employed. Plug 8 and electrical cord 6 are depicted as being dimensioned and configured to comply with US standards for outlet configuration, safety standards and so on, however, this can be varied to suit local conditions.

Electrical cord 6 enters core 2, where it is operatively connected to core wiring. The core wiring may be any type of wiring suitable for carrying electrical power from the electrical cord to locations at the core, in particular, the core wiring will provide an operative connection to electrical wiring within each spire, via sockets, as will be discussed further in reference to later figures.

Core 2 may be generally spherical as in the best mode now contemplated, or it may be another shape or size.

A plurality of light passing spires 4 extend radially from core 2. The plurality of spires in the preferred embodiment shown is 14 total spires, however, any number of spires may be employed from 2 to whatever is practicable. The arrangement of the spires may be varied to be symmetrical for the number of spires employed, or the spires may be asymmetrical. The arrangement may also be left to the user, as the individual spires are removable and replaceable. The lengths of the spires may vary from spire to spire in order to provide a more pleasing star or cross shape, for example one spire may have a first length while another spire may have a second length, and so on. The form of the individual spires will be discussed further later.

While the term radially is used to describe the extension of the spires from the core, it is to be understood that this term is not used in the purely geometric sense, that is, the spires may extend from a point other than the geometric center of the invention, the spires may extend in angles which are not precisely radial, thus forming patterns among several spires, or the spires may be curved or bent.

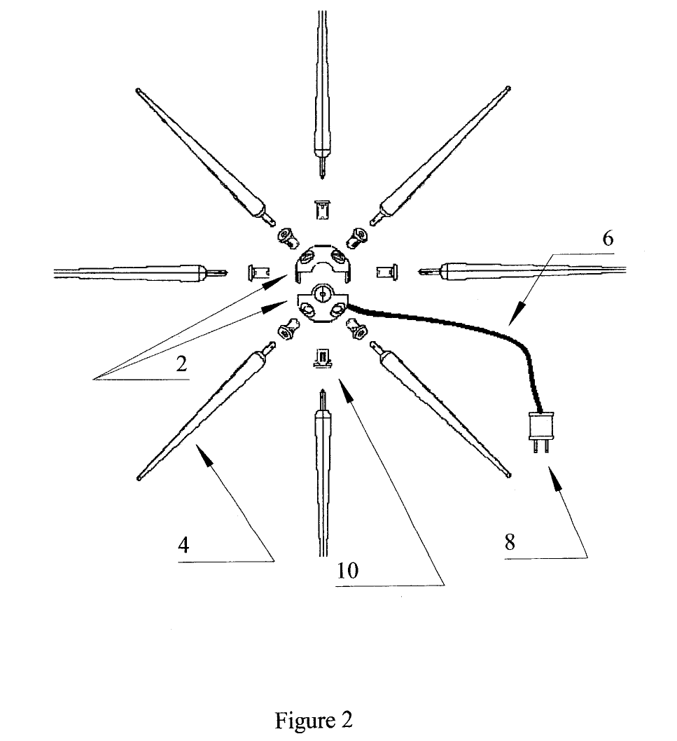

FIG. 2 is an exploded frontal view of the invention, showing major components of the invention. Spire 4 may be seen to be seated in socket 10, which are themselves seated in core 2. Electrical cord 6 has plug 8.

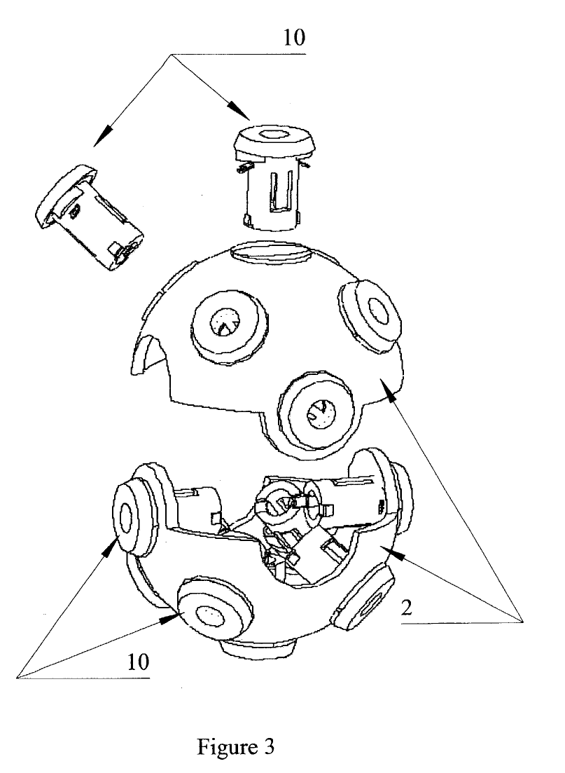

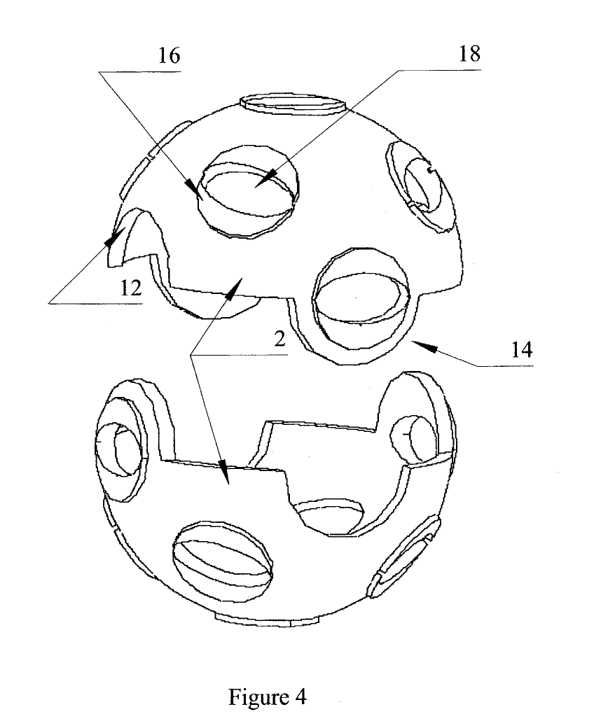

Details of the sockets and core may be better understood in the next two diagrams. FIG. 3 is a partially exploded oblique perspective view of the core and sockets of the invention. Socket 10 connects to core hemisphere 2. FIG. 4 is an exploded oblique perspective view of the core of the invention without sockets, showing in better detail core hemisphere 2. It will be seen that the sockets will project from the exterior of the core through aperture 18 into the interior of the core. Thus the core is rather like a shell having an interior cavity and having apertures extending from the cavity to the exterior of the core.

In order to ease manufacturing burden, core hemisphere 2 may be identical to the matching core hemisphere to which it is attached to form the core. By such methods, a single mold may be used to manufacture a two part core. In particular, notch 12 allows protrusion 14 having one aperture thereon to physically operatively engage with an identical core hemisphere. This not only allows any desired spacing and arrangements of the apertures and thus the light spires, but it further provides additional strength and stability when two core hemispheres are attached together.

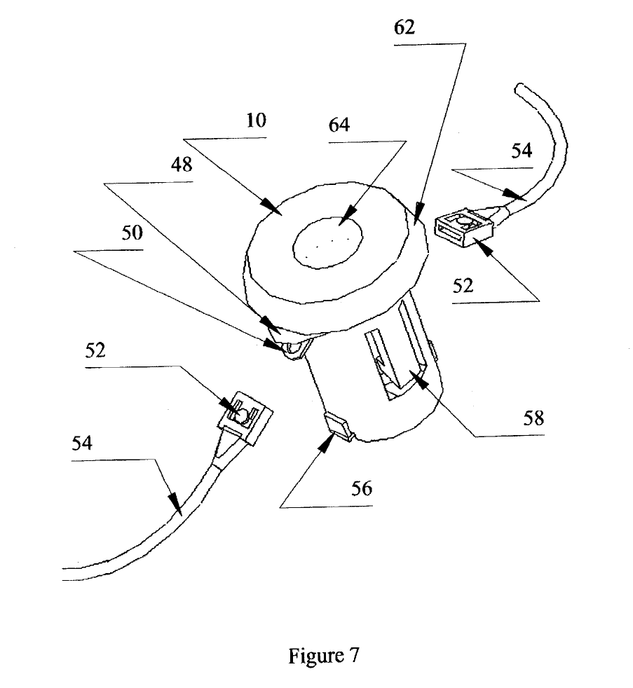

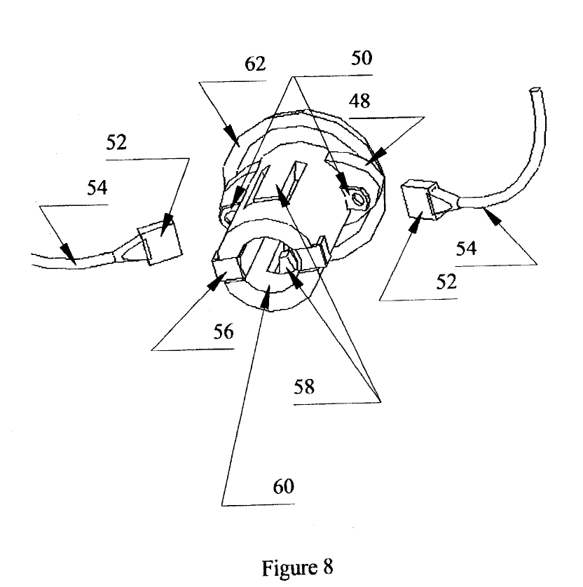

Flange 16 assists in maintaining sockets in aperture 18. Referring briefly to FIGS. 7 and 8, the mechanism of the sockets' connections to the core may be better understood. FIG. 7 is an oblique/side view of one socket of the invention showing partial core wiring, while FIG. 8 is a bottom view of one socket of the invention showing partial core wiring. Socket 10 has electrical terminal 50, retainers 52, and terminal hook 56, as well as well 64, shroud 62, and (FIG. 8) tab 48. It will be appreciated that terminal 50, terminal hook 56 (part of the same unitary body) is made of an electrically conductive material such as copper, aluminum, etc.

Physically operative connection (attachment) of socket 10 to aperture 18 may be accomplished by means of tab 48 and the non-circular shape of aperture 18: socket 10 may be inserted into aperture 18 with tab 48 lined up with the long axis of aperture 18, then glued to permanently secure socket 10 to core 2. It will be seen that shroud 62 will sit on the exterior of core hemisphere 2 and tab 48 on the inside. Tab 48 causes the planform of socket 10 to match that of aperture 18, thus preventing any rotation of the socket within the aperture. This is particularly important in taking the torque applied by removal and replacement of spires (for example when a light within a spire burns out). A strong adhesive is advantageously used to secure socket 10 within aperture 18.

In a presently less favored embodiment, tab 48 and the shroud are separated by a distance slightly smaller than the thickness of core hemisphere 2, thus allowing socket 10 to be inserted into aperture 18 and turned, which is not possible in the presently favored embodiment. The friction resulting between the three elements at the time of twisting will aid in retaining socket 10 in place.

The shroud further acts to conceal the end portions of aperture 18, providing a pleasing exterior appearance for the core. Note that core 2 may itself be of decorative appearance. In addition to lights within the core, it may be textured, colored or shaped for pleasing effect. The shroud may contribute to this appearance by being circular, star shaped, etc.

Physically operative connection of a spire to socket 10 is accomplished by retainer 58, in this embodiment pictured as a clip 58 having a detent (at arrowhead of lead line of clip 58 in FIG. 8). A spire may simply be inserted into well 64.

Terminal 50 extends along the interior of well 64. In the presently preferred embodiment, terminal 50 terminates in a hook 56 which wraps around from the bottom end of well 64 to clasp the socket wall 60. By this means terminal 50 may be securely provided with an operative electrical contact to corresponding terminals on the base of a spire inserted into well 64. Note that in alternative embodiments, terminal 50 may be convexly curved or otherwise protrude slightly into well 64, thus providing an alternative or supplementary form of physical connection of the spire to socket 10, i.e. another source of friction therebetween.

Core wiring(s) 54 may be partially viewed in FIG. 7 and FIG. 8. In the presently preferred embodiment, this wiring is disposed within the cavity of the core. Clips 52 are secured to terminal 50 to provide an electrical source thereto.

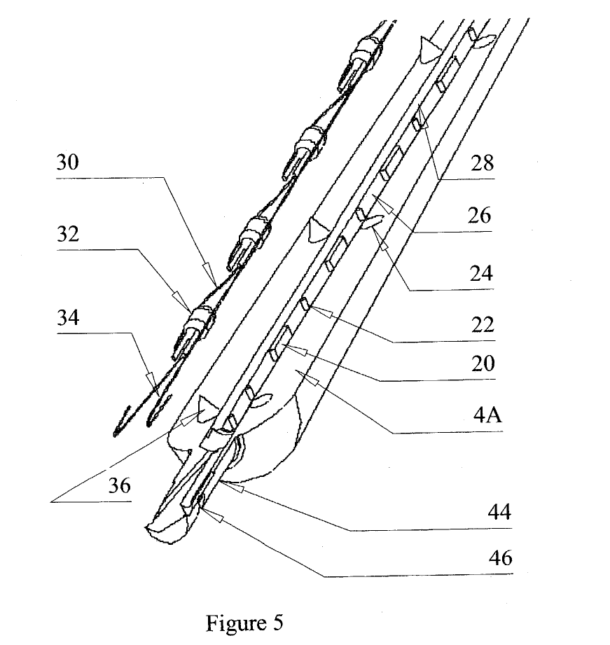

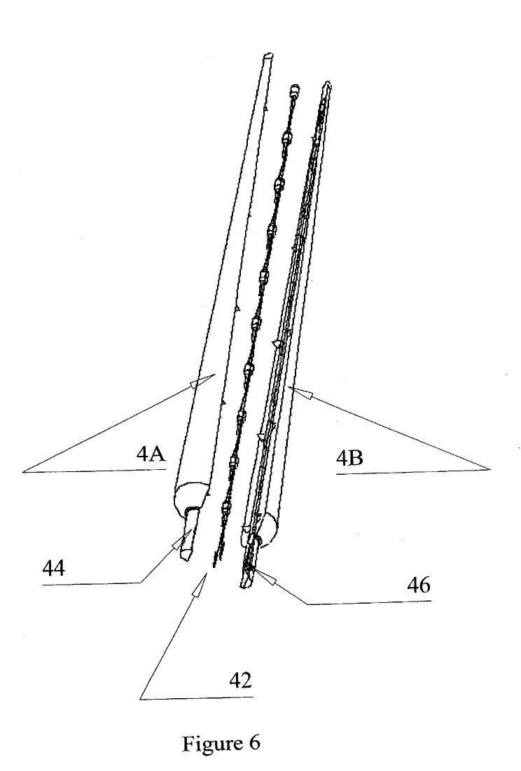

FIG. 5 is a oblique elevated view of one spire component with spire wiring and sub-miniature lights ready for insertion therein. FIG. 6 is an oblique/side exploded view of one spire showing two spire components, spire wiring and sub-miniature lights during assembly of the spire. Spire 4 is composed of at least two parts which are assembled to form a rigid structure. Spire component 4A is one such part. Sandwiched in between the two spire components is spire wiring and lighting assembly 42. Spire base 44 is dimensioned and configured to physically engage with socket 10. For example, notch 46 of the preferred embodiment may provide a modest surface for the detent on retainer 58 to engage with, thus gently retaining the spire in the core.

In other embodiments, spire 4 may screw in (with screw threads on base 44 and in well 64), snap in by equivalent structures, etc.

Spire wiring and lighting assembly 42 may additionally comprise a jig in alternative embodiments discussed below, but in the preferred embodiment, it comprises spire wiring (comprising light to light lead 30 and return lead 34) and small light 32. Small light 32 is in operative electrical connection with leads 30, 34; in the case of return lead 34 of the best mode now contemplated, the connection is indirect, passing through at least one additional light to light lead and at least one additional small light. At the distal end of the end light to light lead 30 and return lead 34 are contacts bent into a U-shape. The contacts project outward from spire base 44 and then (in the preferred embodiment) return along a portion of the length of spire base 44. When the spire is inserted into well 64, the contacts make an operative electrical connection with terminal 50 and its counterpart, thus providing a complete electrical circuit from plug 8 through the entire device.

Physically, the interior of the spire is almost or entirely solid. Small cavities may remain around spire wiring and within small lights (for example, light bulb type lights normally have a partial vacuum in a cavity within the glass light bulb), such trivial cavities are not excluded from the word “solid” as used herein. It will be appreciated that the device of the invention may be made without any voids (for example, by the use of a jig, as described later), and with the use of solid state small lights such as LEDs. Or small voids (such as decorative bubbles, light bulb interiors and small cavities around spire wiring may be present. Either case is included within the word “solid”. In general, solid as used herein refers to the absence of a longitudinal central axial cavity and the absence of other major void areas.

One important benefit of solid construction is added stability and thus longevity of the small lights within. Wiring divider 20 and peg 22 largely fill what empty space would otherwise surround small light 32 and thus hold it extremely securely and add greatly to the durability of the present invention. In alternative embodiments, wiring divider 20 and peg 22 entirely fill all available space within which spire wiring and lighting assembly 42 sits, leaving only spaces, if any, within lights. By contrast, if wiring and lights within the spire are secured only by clips or is allowed to retain itself loosely in place, the device is of greatly reduced durability and the lights suffer a much shorter lifespan.

Protrusion 36 cooperates with a matching depression 24 when the spire component 4A is assembled with another identical spire component such as 4B. Protrusion 36 and depression 24 are dimensioned and configured so as to mate securely together and provide an operative physical connection of the components.

Small light 32 is a sub-miniature light in the preferred embodiment. In practice, this refers to a smaller size of conventional light bulb than is normally used in the “mini lights” sets sold at holiday times in the US. Whereas a typical “mini-light” has a bulb roughly 1.5 cm or more in length, a typical sub-miniature light bulb is normally shorter than 1 cm. In alternative embodiments, the larger “mini-lights” may be used. In general, any type of small light bulb using the traditional tungsten wire or other wire which heats under electrical current will work in the invention, though small size may be desirable for aesthetic reasons.

A discussion of miniature and sub-miniature light bulbs may be obtained at the website of Lumex, Inc. Typical sources of sub-miniature light bulbs may include, for example, Chicago Miniature Lamp, Inc. For example, that company's parts in the “T-1¾ wire terminal” standard are bulbs of length 0.52 inch maximum length, 0.23 inch maximum width, having two 1.0 inch leads, a design voltage of 6.3 to 48.0 volts, a design current of 0.014 to 0.20 amps, and mean spherical candle power of 0.002 up to 0.7 cp, a design life of 1,000 to 50,000 hours and a “half hex” (three sided) filament planform. Other product lines have suitable characteristics as well. Depending upon factors such as energy use, desired brightness, desired lifetime, etc, the choice sub-miniature bulbs may be optimized. However, these options and ranges are by no means limitations on the invention. Bulbs which are omnidirectional or directional may be employed. Flanged or grooved base bulbs or any other base may be employed as well with the addition of suitable wiring. Note that high design life span is extremely desirable in the invention, as for mini and sub-miniature lights, the lights of a spire may be arranged in serial rather than in parallel electrical connection, so the failure of one bulb may result in darkness in an entire spire or even entire ornament. For this reason, in the preferred embodiment the spires are not in a serial circuit with one another, allowing a malfunctioning spire to be easily identified and replaced.

In alternative embodiments, spire wiring may be rearranged so that the small lights are in parallel relationship or on entirely separate circuits. In addition to reliability, this allows easy usage of electronic circuitry which causes the lights to receive electrical power on a timed basis. By timing the power to each spire or even a subset of lights within a spire, the ornament may be made to exhibit changing lighting patterns.

In yet another alternative embodiment, the small lights may have shunt circuits which bypass the light when it ceases to conduct: the simplest such shunt circuit is of course a resistor, though more efficient circuits may be provided at low cost.

In yet other alternative embodiments, light emitting diodes may be used. In particular, multi-color LEDs may be beneficially employed. Further, the recently developed high intensity light emitting diodes may be utilized. One benefit of light emitting diodes is lower energy consumption, another very important benefit is long lifespan.

In other embodiments, spires may be assembled by means of a jig which holds the wiring in shape. The jig and wiring assembly are then molded a second time. The jib may advantageously be the same or a different material from that used to create the spires. Shape of the spires may be altered as well: they spires may be long and narrow, short and squat, branching, flexible, or made to resemble various items such as icicles or other things. The spires may be molded with bubbles therein, or may be molded to be flexible. Surface textures or colors as discussed elsewhere may be added by means of sheathes which fit removably onto the spires, or by coloring or texturing the spire itself.

Core circuitry for timed control of electrical current to the spires may be used to provide a variety of effects such as flashing the entire invention, dimming it or brightening it gradually, causing some spires to flash and others to stay lit, or to otherwise control each serial circuit of lights, or even to provide individual control over lights in parallel circuits.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A hanging ornament comprising:
an electrical cord having a plug;
a core having a plurality of sockets and having core wiring extending to each socket, the core wiring being operatively electrically connected to the electrical cord;
a plurality of light passing spires extending radially from the core; each spire physically connected to one of the sockets;
each spire having spire wiring therein in operative connection to the core wiring at the socket to which the spire is physically connected; whereby an operative electrical connection is established to the spire wiring of each spire;
each set of spire wiring having a plurality of small lights within the light passing spire.

2. The ornament of claim 1, wherein each of the plurality of light passing spires is furthermore solid.

3. The ornament of claim 1, wherein the core further comprises a cavity within the core, and wherein each of the plurality of sockets further comprises an aperture extending from the cavity to the exterior of the core.

4. The ornament of claim 3, wherein the core wiring is disposed within the cavity.

5. The ornament of claim 1, wherein the plurality of small lights within the light passing spire are in serial electrical relationship to one another.

6. The ornament of claim 1, wherein the plurality of small lights within the light passing spire further comprise miniature light bulbs.

7. The ornament of claim 1, wherein the plurality of small lights within the light passing spire further comprise sub-miniature light bulbs.

8. The ornament of claim 1, wherein the plurality of small lights within the light passing spire further comprise light emitting diodes.

9. The ornament of claim 8, wherein the plurality of light emitting diodes within the light passing spire further comprise high intensity light emitting diodes.

10. The ornament of claim 1, wherein each light passing spire further comprises:
a plurality of wiring voids;
a plurality of light bulb voids;
at least first and second individual spire components, each spire component being dimensioned and configured to physically connect to the other spire component in a physical relationship which leaves only the wiring voids and the light bulb voids;
each light bulb void being substantially occupied by one light bulb; and
each wiring void being substantially occupied by one section of spire wiring.

11. The ornament of claim 8, wherein the first and second spire components are identical.

12. The ornament of claim 8, wherein the first spire component further comprises a jig holding the spire wiring and small light bulbs.

13. The ornament of claim 1, wherein the spires are rigid.

14. The ornament of claim 1, wherein the spires are flexible.

15. The ornament of claim 1, wherein each spire may be individually removed from the socket to which it is physically connected.

16. The ornament of claim 12, wherein the operative connection between the core wiring and the spire wiring at each socket permits removal of the spire in the socket without physical disassembly of the wiring.

17. The ornament of claim 1, wherein the exterior of the spires comprises a texture selected from the group consisting of: smooth texture, faceted texture, knurled texture, straight grooved texture, spiraled grooved texture, and combinations thereof.

18. The ornament of claim 1, wherein the spires further comprise a material selected from the group consisting of: clear polymer, transparent colored polymer, translucent polymer, clear glass, transparent colored glass, translucent glass, and combinations thereof.

19. The ornament of claim 18, wherein the polymer is selected from the group consisting of clear hard PVC, acrylic, polycarbonate, PETG and combinations thereof.

20. The ornament of claim 1, wherein each spire further comprises: at least one removable light passing sheath covering the exterior surface of the spire, wherein the light passing sheath is selected from the group consisting of: clear polymer, transparent colored polymer, translucent polymer, clear glass, transparent colored glass, translucent glass, and combinations thereof.

21. The ornament of claim 1, further comprising at least one light disposed at the core, the light in operative connection with the core wiring.

22. The ornament of claim 1, wherein the core further possesses at least one limitation selected from the list comprising: decorative surface texture, decorative shape, decorative color.

23. The ornament of claim 1, wherein each spire further comprises:
a second spire wiring therein in operative connection to the core wiring at the socket to which the spire is physically connected; whereby an operative electrical connection is established to the second spire wiring of each spire;
each second set of spire wiring having a plurality of small lights within the light passing spire.

24. The ornament of claim 1, wherein the small lights are colored.

25. The ornament of claim 1, further comprising means for timed control of the electrical supply of the small lights.

26. The ornament of claim 1, wherein the plurality of small lights within the light passing spire are in parallel electrical relationship to one another.

27. The ornament of claim 1, further comprising:
at least one electrically actuated sound device in operative connection to the electrical cord, whereby the device may make sound when in operation.

28. The ornament of claim 1, wherein a first one of the plurality of spires has a first length, and a second one of the plurality of spires has a second length.
